(19) United States
(12) Patent Application Publication
(10) Pub. No.: US 2026/0291228 A1
(43) Pub. Date: Sep. 24, 2026

(54) CONTROL APPARATUS, POWER CONDITIONING SYSTEM, CONTROL METHOD, AND PROGRAM

(71) Applicant: MITSUBISHI HEAVY INDUSTRIES, LTD., Tokyo (JP)

(72) Inventor: Ryo IIDA, Tokyo (JP)

(73) Assignee: MITSUBISHI HEAVY INDUSTRIES, LTD., Tokyo (JP)

(21) Appl. No.: 19/168,740

(22) PCT Filed: Oct. 3, 2023
(86) PCT No.: PCT/JP2023/036062

§ 371 Date: Sep. 24, 2025

(30) Foreign Application Priority Data
Mar. 31, 2023 (JP) 2023-057834

(51) Int. Cl. H02J 3/0012; H02J 3/001; H02J 3/32; H02J 7/00; H02J 7/50; H02J 7/64; H02J 7/90

(52) U.S. Cl. CPC H02J 3/0012; H02J 3/00125; H02J 3/32; H02J 7/50; H02J 7/64; H02J 7/855; H02J 7/933; H02J 2207/20; H02J 2207/30

(57) ABSTRACT

A control apparatus comprising: a voltage acquisition unit that acquires a voltage of a DC bus connecting a power conditioner and a storage battery unit; an output power limiting unit that sets to zero an output power limit of PCS output power which is power output to the load side by the power conditioner when the voltage exceeds an upper limit threshold value or when the voltage falls below a lower limit threshold value; and a limited power release unit that gradually increases or gradually decreases the output power limit after the output power limit is set to zero.

### TECHNICAL FIELD

The present disclosure relates to a control device, a power conditioning system, a control method, and a program.

This application claims priority based on Japanese Patent Application No. 2023-057834 filed in Japan on Mar. 31, 2023, and this content is incorporated herein by reference.

### BACKGROUND ART

In recent years, energy storage systems have been used in various places such as power generation facilities and factories that use renewable energy. The energy storage system includes a plurality of storage battery units each having a storage battery and a DC/DC converter, a power conditioning system (PCS), and a DC bus that connects the storage battery unit and the PCS.

In addition, in the energy storage system, for example, when the DC/DC converter trips, and the total chargeable/dischargeable electric power of the entire storage battery unit is smaller than the PCS output electric power output from the PCS to the load side (the electric power system when the electric power storage unit is discharged, and the electric power storage unit when the electric power storage unit is charged), overdischarge of the storage battery or overvoltage of the DC bus occurs, and the system is stopped. In order to continue the operation of the energy storage system, it is necessary to limit the PCS output electric power in a case where the voltage of the DC bus greatly decreases or increases. For example, PTL 1 discloses that, when a load is activated in a battery pack (energy storage system) configured with a plurality of single cells, in a case where overdischarge of any single cell is detected, the electric power supply from the battery pack to the load is limited or stopped.

### CITATION LIST

### Patent Literature

[PTL 1] Japanese Patent No. 4,821,363

### SUMMARY OF INVENTION

### Technical Problem

FIG. 8 is a diagram illustrating an example of output limiting processing of the energy storage system in the related art.

As shown in FIG. 8, in the energy storage system of the related art, an output power limit for limiting the PCS output electric power P_{PCS} is changed according to an increase or decrease in the DC bus voltage V_{dc}. When the output power limit is a positive value, this indicates charging to the storage battery unit, and when the output power limit is a negative value, this indicates discharging from the storage battery unit.

For example, when a trip occurs during discharge from the storage battery unit, the total dischargeable electric power of the storage battery unit decreases (a1 in FIG. 8), and the DC bus voltage Vdc decreases (a2 in FIG. 8). At this time, when the energy storage system detects a decrease in the DC bus voltage V_{dc_t91} at time t91, the energy storage system gradually reduces the PCS output electric power P_{PCS} (gradually increases the value of the output power limit) and limits the discharge from the storage battery unit (a3 in FIG. 8). Then, at time t92, the PCS output electric power P_{PCS} can be reduced to the total dischargeable electric power of the storage battery unit, and thus the storage battery system stops the processing of limiting the discharge electric power. However, the DC bus voltage V_{dc} continues to decrease until the PCS output electric power P_{PCS} is balanced with the total dischargeable electric power. In this case, the DC bus voltage V_{dc} continues to decrease until time t92, and thereafter, the energy storage system continues to operate while maintaining the DC bus voltage in an abnormally low state (value of a DC bus voltage V_{dc_t92} at time point of time t92) (a4 in FIG. 8).

Similarly, it is assumed that the DC/DC bus of one storage battery unit trips when charging the storage battery unit. In this case, the total chargeable electric power of the storage battery unit decreases (b1 in FIG. 8), and the DC bus voltage V_{dc} increases (b2 in FIG. 8). At this time, when the energy storage system detects the increase in a DC bus voltage V_{dct_93} at time t93, the energy storage system gradually reduces the PCS output electric power P_{PCS} (gradually reduces the value of the output power limit) and limits the charging to the storage battery unit (b3 in FIG. 8). Then, at time t94, the PCS output electric power P_{PCS} can be reduced to the total chargeable electric power of the storage battery unit, and thus the storage battery system stops the processing of limiting the charge electric power. However, the DC bus voltage Vdc continues to rise until the PCS output electric power P_{PCS} is balanced with the total chargeable electric power. In this case, the DC bus voltage V_{dc} continues to rise until time t94, and thereafter, the energy storage system continues to operate while maintaining the DC bus voltage in an abnormally high state (value of a DC bus voltage V_{dc_t94} at time point of time t94) (b4 in FIG. 8).

An object of the present disclosure is to provide a control device, a power conditioning system, a control method, and a program that can suppress a DC bus voltage from exceeding a normal operation voltage range and continue an operation when a decrease and an increase in the DC bus voltage are detected.

### Solution to Problem

According to an aspect of the present disclosure, there is provided a control device including: a voltage acquisition unit that acquires a voltage of a DC bus connecting a power conditioning system (PCS) and a storage battery unit; an output power limiting unit that sets an output power limit of PCS output electric power which is electric power output to a load side by the PCS to zero when the voltage exceeds an upper limit threshold value or when the voltage falls below a lower limit threshold value; and a limited power release unit that gradually increases or gradually decreases the output power limit after the output power limit is set to zero.

According to still another aspect of the present disclosure, there is provided a control method including: a step of acquiring a voltage of a DC bus connecting a power conditioning system (PCS) and a storage battery unit; a step of setting an output power limit of PCS output electric power which is electric power output to a load side by the PCS to zero when the voltage exceeds an upper limit threshold value or when the voltage falls below a lower limit threshold value; and a step of gradually increasing or gradually decreasing the output power limit after the output power limit is set to zero.

According to still another aspect of the present disclosure, there is provided a program that causes a control device to execute a step of acquiring a voltage of a DC bus connecting a power conditioning system (PCS) and a storage battery unit, a step of setting an output power limit of PCS output electric power which is electric power output to a load side by the PCS to zero when the voltage exceeds an upper limit threshold value or when the voltage falls below a lower limit threshold value, and a step of gradually increasing or gradually decreasing the output power limit after the output power limit is set to zero.

### Advantageous Effects of Invention

According to the above aspect, when the decrease and the increase in the DC bus voltage are detected, it is possible to suppress the DC bus voltage from exceeding the normal operation voltage range and to continue the operation.

### BRIEF DESCRIPTION OF DRAWINGS

FIG. 1 is a diagram showing an overall configuration of an energy storage system according to an embodiment.

FIG. 2 is a block diagram showing a functional configuration of a control device according to the embodiment.

FIG. 3 is a diagram for describing an upper limit threshold value and a lower limit threshold value of a DC bus voltage according to the embodiment.

FIG. 4 is a flowchart showing an example of output control processing of the control device according to the embodiment.

FIG. 5 is a first diagram for describing output control processing according to the embodiment.

FIG. 6 is a second diagram for describing output control processing according to the embodiment.

FIG. 7 is a flowchart showing an example of processing of updating an output power limit of the control device according to the embodiment.

FIG. 8 is a diagram illustrating an example of output limiting processing of an energy storage system in the related art.

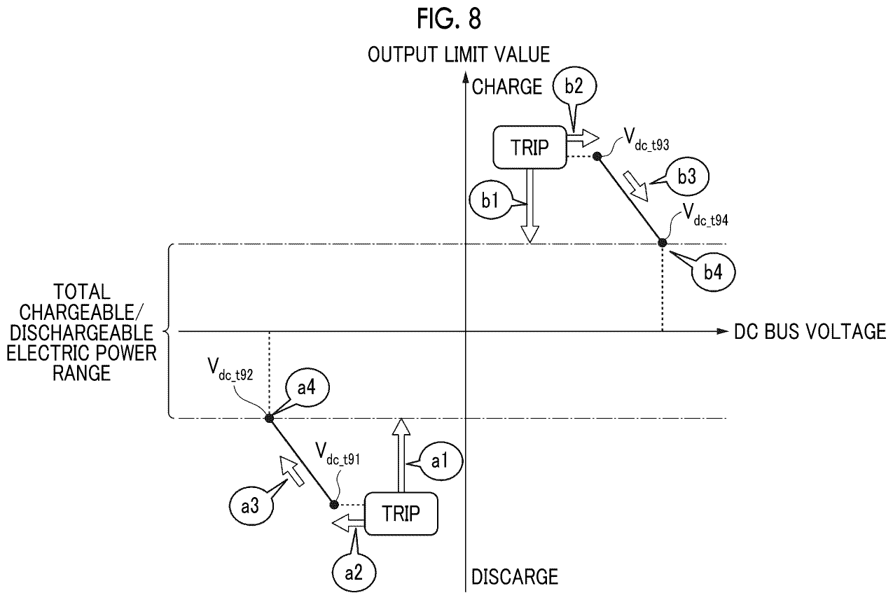

### DESCRIPTION OF EMBODIMENTS

### Overall Configuration of Energy Storage System

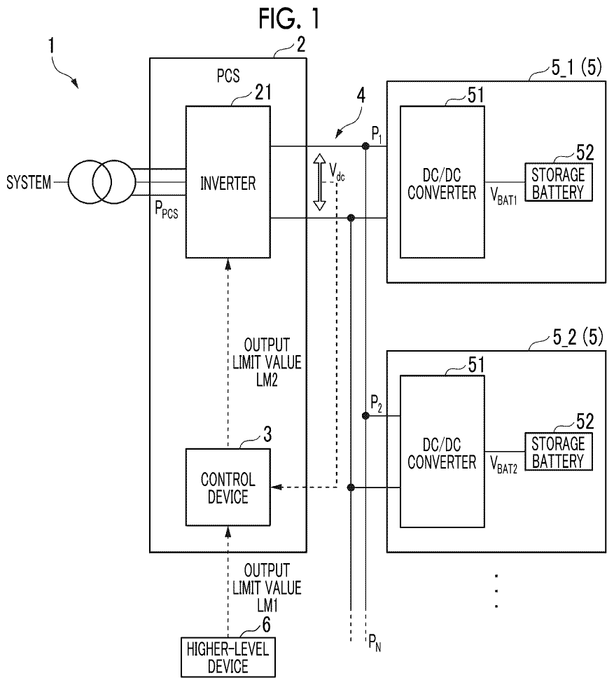

FIG. 1 is a diagram showing an overall configuration of an energy storage system according to an embodiment.

As shown in FIG. 1, the energy storage system 1 includes a power conditioning system (PCS) 2, a control device 3, a DC bus 4, and a plurality of storage battery units 5.

The PCS 2 is a power conditioning system that is interconnected with an electric power system. The PCS 2 includes an inverter 21 that is a bidirectional inverter that converts AC power and DC power. The PCS 2 converts the DC power discharged from each storage battery unit 5 into AC power by the inverter 21 and outputs the AC power to the electric power system. In addition, the PCS 2 converts the AC power supplied from the electric power system into DC power by the inverter 21 and outputs the DC power to each storage battery unit 5. The electric power output from the PCS 2 to the load side is also referred to as PCS output electric power P_{PCS}. The PCS output electric power P_{PCS} is electric power output from the PCS 2 to the electric power system when the storage battery unit 5 is discharged, and is electric power output from the PCS 2 to the storage battery unit 5 when the storage battery unit 5 is charged.

The control device 3 sets an output power limit LM2 of the PCS 2 such that the electric power (PCS output electric power P_{PCS}) output to the load side by the PCS 2 is within the electric power (P₁+P₂+ . . . +P_{N}) that can be charged or discharged by the entire storage battery unit 5. The control device 3 normally receives the output power limit LM1 of the PCS 2 from a host device 6 and controls the PCS 2 according to the output power limit LM1. The specific functional configuration of the control device 3 will be described later.

The DC bus 4 is a bus for connecting the PCS 2 and the plurality of storage battery units 5.

The plurality of storage battery units 5 are connected in parallel to the PCS 2 via the DC bus 4. Each storage battery unit 5 includes a DC/DC converter 51 and a storage battery 52. The DC/DC converter 51 converts the DC power supplied from the PCS 2 into a predetermined voltage to charge the storage battery 52. In addition, the DC/DC converter 51 converts the discharge electric power of the storage battery 52 into a predetermined voltage and supplies the converted electric power to the PCS 2.

Although a configuration example in which the PCS 2 includes the control device 3 is shown in FIG. 1, the present disclosure is not limited thereto. In another embodiment, the control device 3 may be provided outside the PCS 2 as different hardware.

### Functional Configuration of Control Device

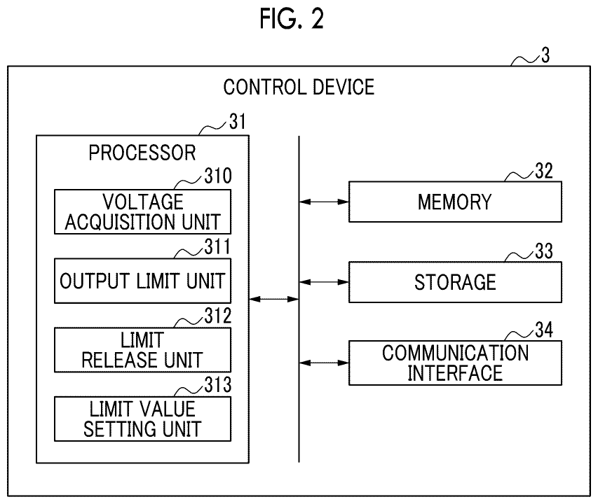

FIG. 2 is a block diagram showing a functional configuration of a control device according to the embodiment.

As shown in FIG. 2, the control device 3 includes a processor 31, a memory 32, a storage 33, and a communication interface 34.

The processor 31 operates according to a predetermined program to exhibit functions as a voltage acquisition unit 310, an output power limiting unit 311, a limited power release unit 312, and a output power limit value setting unit 313.

The voltage acquisition unit 310 acquires a voltage (hereinafter also referred to as a DC bus voltage V_{dc}) of the DC bus 4 connecting the PCS 2 and the storage battery unit 5 from a voltage sensor (not shown) provided in the DC bus 4.

In a case where the DC bus voltage Vdc exceeds an upper limit threshold value VUL or falls below a lower limit threshold value VLL, the output power limiting unit 311 sets to zero the output power limit LM2 of the PCS output electric power PPCS, which is the electric power output to the load side by the PCS 2. Details of the upper limit threshold value VUL and the lower limit threshold value VLL will be described later.

The limited power release unit 312 gradually increases or decreases the output power limit LM2 after the output power limit LM2 is set to zero.

The output power limit value setting unit 313 fixes the output power limit LM2 at the current value in a case where the DC bus voltage V_{dc} becomes the upper limit value Vmax or the lower limit value Vmin of a normal operation voltage range R determined in advance. In addition, in a case where the output power limit value setting unit 313 receives the output power limit LM1 of the PCS output electric power P_{PCS} from the host device 6, when the output power limit LM1 is equal to or less than the output power limit LM2, the output power limit value setting unit 313 overwrites the output power limit LM2 with the value of the output power limit LM1. Details of the normal operation voltage range R will be described later.

The predetermined program executed by the processor 31 is stored in a computer-readable recording medium. In addition, examples of the computer-readable recording medium include a magnetic disk, a magneto-optical disk, a CD-ROM, a DVD-ROM, and a semiconductor memory. In addition, the computer program may be distributed to a computer via a communication line, and the computer receiving the distribution may execute the program. Further, the program may be a program for realizing some of the functions described above. Further, the program may be a so-called difference file (difference program) that can realize the functions described above in combination with a program already recorded in a computer system.

The memory 32 has a memory area necessary for the operations of the processor 31.

The storage 33 is a so-called auxiliary storage device and is, for example, a hard disk drive (HDD), a solid state drive (SSD), or the like. The storage 33 stores data that is acquired, generated, and referred to by each unit of the processor 31 during processing.

The communication interface 34 is an interface for transmitting and receiving various types of data and control signals between the PCS 2, the host device 6, and the like.

### Regarding Upper Limit Threshold Value and Lower Limit Threshold Value of DC Bus Voltage

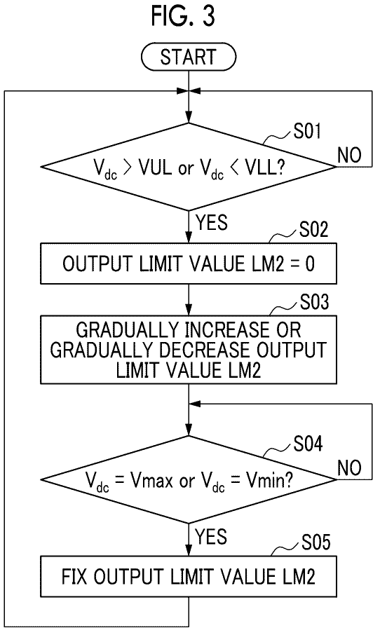

FIG. 3 is a diagram for describing an upper limit threshold value and a lower limit threshold value of a DC bus voltage according to the embodiment.

FIG. 3 shows an example of the upper limit threshold value VUL, the lower limit threshold value VLL, and the normal operation voltage range R of the DC bus voltage V_{dc}.

The DC bus voltage of each storage battery unit 5 in a no-load state (when charging and discharging are not performed) is used as a reference voltage V₀.

The normal operation voltage range R is a voltage fluctuation range caused by droop during normal operation of the storage battery unit 5 centered on the reference voltage V₀. An upper limit value of the normal operation voltage range is also referred to as Vmax, and a lower limit value is also referred to as Vmin.

The upper limit threshold value VUL and the lower limit threshold value VLL are threshold values for detecting an abnormality in the voltage of the DC bus 4. Considering the transient voltage fluctuations due to overshoot or resonance during voltage control, an error of the voltage sensor, and the like, the upper limit threshold value VUL is set to a value larger than the upper limit value Vmax of the normal operation voltage range by a predetermined amount α. Similarly, the lower limit threshold value VLL is set to a value lower than the lower limit value Vmin of the normal operation voltage range by a predetermined amount α. The predetermined amount a may be optionally changed according to the characteristics of the storage battery unit 5 or the like.

### Processing Flow of Control Device

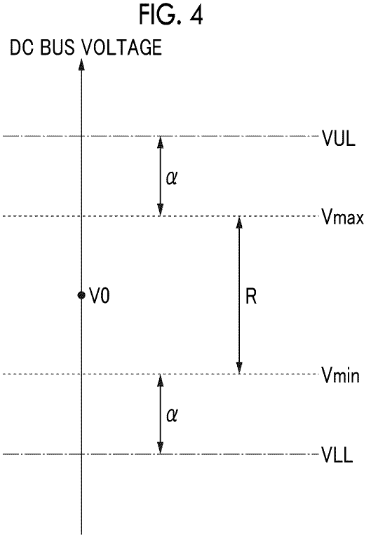

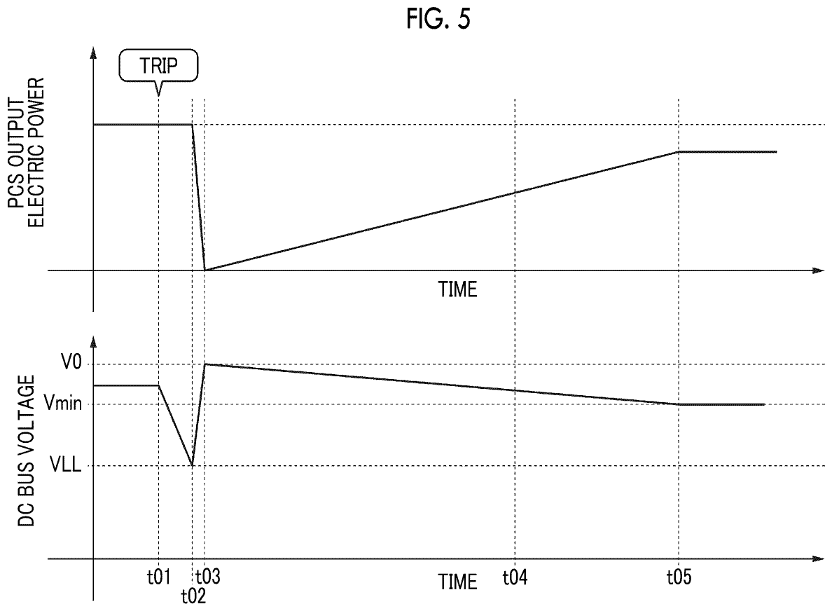

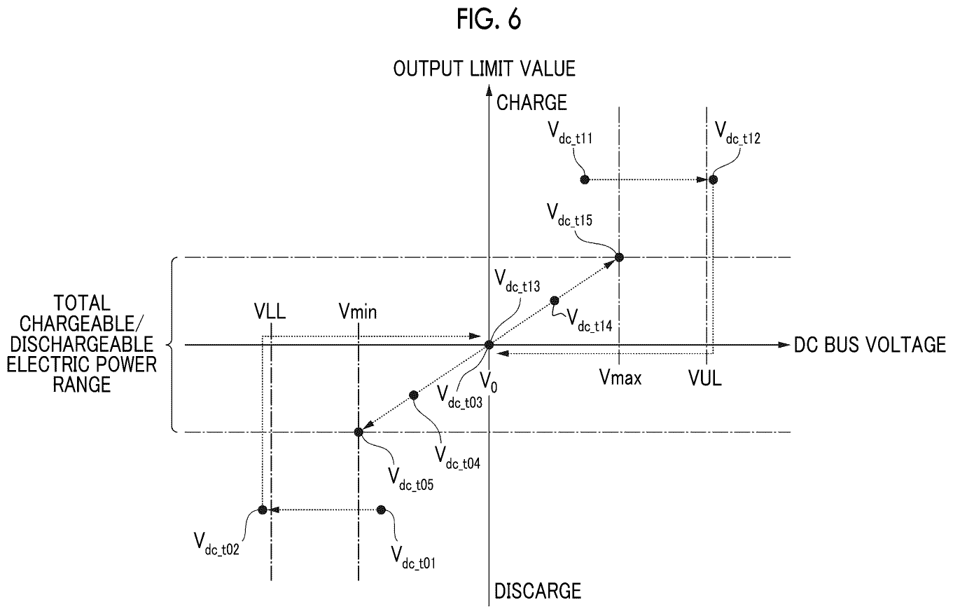

FIG. 4 is a flowchart showing an example of output control processing of the control device according to the embodiment. FIG. 5 is a first diagram for describing the output control processing according to the embodiment. FIG. 6 is a second diagram for describing the output control processing according to the embodiment.

Hereinafter, the output control processing flow due to a fluctuation in the DC bus voltage of the control device 3 will be described with reference to FIGS. 4 to 6.

During the series of processing in FIG. 3, the voltage acquisition unit 310 acquires the DC bus voltage V_{dc} at each time. The output power limiting unit 311 determines whether the DC bus voltage V_{dc} acquired by the voltage acquisition unit 310 exceeds the upper limit threshold value VUL or falls below the lower limit threshold value VLL (step S01).

When the storage battery unit 5 is charged, in a case where the DC bus voltage V_{dc} does not exceed the upper limit threshold value VUL (step S01; NO), the output power limiting unit 311 returns to step S01 and continues to monitor the DC bus 4. In addition, when the storage battery unit 5 is discharged, in a case where the DC bus voltage V_{dc} does not fall below the lower limit threshold value VLL (step S01; NO), the output power limiting unit 311 returns to step S01 and continues to monitor the DC bus 4.

Meanwhile, in a case where the DC bus voltage V_{dc} exceeds the upper limit threshold value VUL or in a case where the DC bus voltage V_{dc} falls below the lower limit threshold value VLL (step S01; YES), the output power limiting unit 311 executes the output control processing of the PCS 2.

First, the output control processing during the discharge of the energy storage system 1 will be described. FIG. 5 shows a time series of the PCS output electric power P_{PCS} and the DC bus voltage V_{dc} during discharge of the storage battery unit 5_2, for example, among the three storage battery units 5_1, 5_2, and 5_3 included in the energy storage system 1. In addition, FIG. 6 shows a correspondence between the DC bus voltage V_{dc} of the storage battery unit 5_2 measured at each time t01 to t05 in FIG. 5 and the output power limit LM2.

In the example of FIG. 5, a trip has occurred in the storage battery unit 5_2 at time t01. In this case, the electric power that can be discharged by the entire storage battery unit 5 is P1+P2+P3 before time t01, but is reduced to P1+P3 after time t01. In addition, at this time, the PCS 2 cannot know the occurrence of the trip of the storage battery unit 5_2. Therefore, the PCS output electric power P_{PCS} does not change at the time point of time t01. Therefore, after time t01, the PCS output electric power P_{PCS} is greater than the dischargeable electric power P1+P3 of the entire storage battery unit 5, and the DC bus voltage V_{dc} decreases with time as in the example of FIG. 5.

Here, a case where the output control processing of the present embodiment is not performed will be described as a comparative example. Assuming that a voltage V_{BAT1} of the storage battery unit 5_1 is the highest among the storage battery units 5_1 and 5_3 that are in operation, V_{BAT1} is approximately equal to V_{dc}. In this case, the storage battery unit 5_1 compensates for the insufficient load amount regardless of the control of the DC/DC converter 51 of the storage battery unit 5_1. In this case, the storage battery unit 5_1 may be overdischarged.

In order to suppress overdischarge of the storage battery unit 5_1, the control device 3 according to the present embodiment executes the output control processing as described below.

In the examples of FIGS. 5 and 6, after time t01 when the trip occurs, the DC bus voltage V_{dc} decreases with time, and a DC bus voltage V_{dc_t02} falls below the lower limit threshold value VLL at time t02 (step S01; YES). In this case, the output power limiting unit 311 sets the output power limit LM2 of the PSC 2 to zero (step S02). When the output power limit LM2 of the PCS 2 becomes zero, at time t03, the PCS output electric power P_{RCS} of the PCS 2 becomes zero, and a DC bus voltage V_{dc_t03}returns (increases) to the reference voltage V₀ at the time of no load.

After the output power limit LM2 of the PCS 2 is set to zero, the limited power release unit 312 gradually decreases the output power limit LM2 of the PCS 2 (step S03).

Next, the output power limit value setting unit 313 determines whether or not the DC bus voltage V_{dc} has become the lower limit value Vmin of the normal operation voltage range R (step S04).

At time t04 in FIGS. 5 and 6, a DC bus voltage V_{dc_t04} has not achieved the lower limit value Vmin of the normal operation voltage range R (step S04; NO). In this case, the output power limit value setting unit 313 waits until the next determination timing.

In addition, at time t05 in FIGS. 5 and 6, a DC bus voltage V_{dc_t05} becomes equal to the lower limit value Vmin (step S04; YES). In this case, the output power limit value setting unit 313 stops the gradual decrease of the output power limit LM2 and fixes the output power limit LM2 at the current value (step S05). The output power limit value setting unit 313 determines that the DC bus voltage V_{dc_t05} is equal to the lower limit value Vmin (step S04; YES) when the value of the DC bus voltage V_{dc_t05} is within a predetermined range from the lower limit value Vmin, and may fix the output power limit LM2 at the current value (step S05).

When the DC bus voltage V_{dc} becomes the lower limit value Vmin of the normal operation voltage range R, as in the example of FIG. 6, the output electric power P_{PCS} of the PCS 2 substantially coincides with the maximum electric power that can be discharged from the entire storage battery unit 5. Therefore, even when the storage battery unit 5_2 trips during discharge, the control device 3 can continue the operation of the energy storage system 1 by controlling such that the other operating storage battery 5 units discharge with the maximum dischargeable electric power and the DC bus voltage V_{dc} remains within the normal operation voltage range R.

In addition, output control during charging of the energy storage system 1 will be described with reference to FIG. 6. FIG. 6 shows the correspondence between the DC bus voltage V_{dc} measured at times t11 to t15 during charging and the output power limit LM2.

For example, it is assumed that the storage battery unit 5_2 trips at time t11. In this case, at the time point of time t11, the output power limit LM2 of the PCS 2 and the PCS output electric power P_{PCS} do not change, but the DC bus voltage Vdc increases with time and exceeds the upper limit threshold value VUL at the time point of time t12 (step S01; YES).

In this case, the output power limiting unit 311 sets the output power limit LM2 of the PSC 2 to zero (step S02). When the output power limit LM2 of the PCS 2 becomes zero, at time t13, the PCS output electric power P_{PCS} of the PCS 2 becomes zero, and a DC bus voltage V_{dc_t13} returns (decreases) to the reference voltage V₀ at the time of no load.

After the output power limit LM2 of the PCS 2 is set to zero, the limited power release unit 312 gradually increases the output power limit LM2 of the PCS 2 (step S03).

Next, the output power limit value setting unit 313 determines whether or not the DC bus voltage V_{dc} has become the upper limit value Vmax of the normal operation voltage range R (step S04).

At time t14 in FIG. 6, a DC bus voltage V_{dc_t14} has not achieved the upper limit value Vmax of the normal operation voltage range R (step S04; NO). In this case, the output power limit value setting unit 313 waits until the next determination timing.

In addition, at time t15 in FIG. 6, a DC bus voltage V_{dc_t15} becomes equal to the upper limit value Vmax (step S04; YES). In this case, the output power limit value setting unit 313 stops the gradual increase of the output power limit LM2 and fixes the output power limit LM2 at the current value (step S05). The output power limit value setting unit 313 determines that the DC bus voltage V_{dc_t15} is equal to the upper limit value Vmax (step S04; YES) when the value of the DC bus voltage V_{dc_t15} is within a predetermined range from the upper limit value Vmax, and may fix the output power limit LM2 at the current value (step S05).

When the DC bus voltage V_{dc} becomes the upper limit value Vmax of the normal operation voltage range R, as in the example of FIG. 6, the output electric power P_{PCS} of the PCS 2 substantially coincides with the maximum electric power that can be charged from the entire storage battery unit 5. Therefore, even when the storage battery unit 5_2 trips during charge, the control device 3 can continue the operation of the energy storage system 1 by controlling such that the other operating storage battery 5 units charge with the maximum chargeable electric power and the DC bus voltage V_{dc} remains within the normal operation voltage range R.

After the output power limit LM2 is fixed, the control device 3 returns to step S01. The control device 3 repeatedly performs a series of processing in FIG. 3 during the operation of the energy storage system 1 in this manner.

In step S03, it is desirable that the limited power release unit 312 sets a time constant that is sufficiently larger than that in normal voltage control to gradually increase or gradually decrease the output power limit LM2. For example, the limited power release unit 312 sets a time constant such that time taken for the DC bus voltage to reach the upper limit value Vmax or the lower limit value Vmin of the normal operation voltage range R after the DC bus voltage becomes the reference voltage V₀ is X seconds. The value of X may be optionally changed according to the characteristics of the storage battery unit 5 or the like.

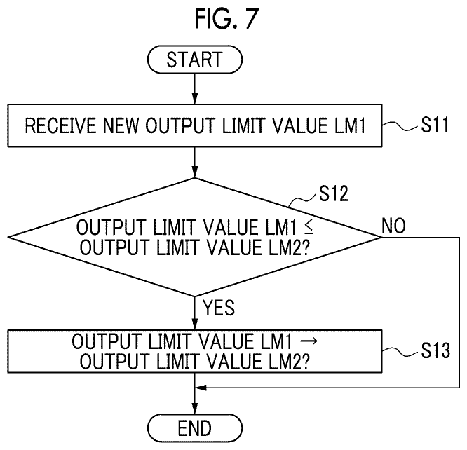

FIG. 7 is a flowchart showing an example of processing of updating an output power limit of the control device according to the embodiment.

The control device 3 may execute the processing shown in FIG. 7 to update the output power limit LM2 of the PCS 2 according to the command of the host device 6.

For example, when the control device 3 detects that the DC bus voltage V_{dc} has exceeded the upper limit threshold value VUL or has fallen below the lower limit threshold value VLL in step S01 of FIG. 3, the control device 3 may perform abnormality notification to the host device 6. In addition, the host device 6 receives an operation of specifying the output power limit LM1 of the PCS 2 from the administrator of the energy storage system 1 and transmits the output power limit LM1 to the control device 3.

In this case, the control device 3 executes the processing shown in FIG. 7. Specifically, when the new output power limit LM1 is received from the host device 6 (step S11), the output power limit value setting unit 313 of the control device 3 determines whether or not the output power limit LM1 is equal to or less than the output power limit LM2 (step S12). In a case where the output power limit LM1 is equal to or less than the output power limit LM2 (step S12; YES), the output power limit value setting unit 313 sets the value of the output power limit LM2 to the value of the output power limit LM1 received from the host device 6 (step S13). Meanwhile, when the output power limit LM1 is greater than the output power limit LM2 (step S12; NO), the output power limit value setting unit 313 ends the processing without changing the value of the output power limit LM2.

That is, when the control device 3 detects the abnormality in the DC bus voltage V_{dc} (step S01 in FIG. 3; YES), the control device 3 executes a series of processing in FIG. 3 to perform automatic control to provisionally change the output power limit LM2. In addition, in a case where the control device 3 receives the new output power limit LM1 from the host device 6 in a normal time (when the DC bus voltage V_{dc} is within the normal operation voltage range R), the control device 3 resets the output power limit LM2 in accordance with the output power limit LM1 when the output power limit LM1 is equal to or less than the output power limit LM2. Thereafter, the energy storage system 1 continues the operation along the output power limit LM1 specified by the host device 6. For example, after the storage battery unit 5_2 is repaired or replaced and becomes operable, the output power limit LM2 is reset by the output power limit LM1 from the host device 6, and accordingly, it is possible to maximize the electric power that can be charged or discharged by the entire energy storage system 1.

### Operations and Effects

As described above, the control device 3 according to the present embodiment includes: the voltage acquisition unit 310 that acquires the DC bus voltage V_{dc} of the DC bus 4 connecting the PCS 2 and the storage battery unit 5; the output power limiting unit 311 that sets the output power limit LM2 of the PCS output electric power P_{PCS} which is electric power output to the load side by the PCS 2 to zero when the DC bus voltage V_{dc} exceeds the upper limit threshold value VUL or when the DC bus voltage V_{dc} falls below the lower limit threshold value VLL; and the limited power release unit 312 that gradually increases or gradually decreases the output power limit LM2 after the output power limit LM2 is set to zero.

In this manner, when the control device 3 detects the abnormality in the DC bus voltage V_{dc}, the control device 3 can suppress the DC bus voltage V_{dc} from exceeding the normal operation voltage range R and continue the operation by temporarily setting the output power limit LM2 of the PCS 2 to zero, returning the DC bus voltage V_{dc} to the reference voltage V₀, and then gradually increasing or decreasing the output power limit LM2.

In addition, the control device 3 further includes the output power limit value setting unit 313 that fixes the output power limit LM2 by stopping a gradual increase or a gradual decrease in the output power limit LM2 when the DC bus voltage V_{dc} becomes the upper limit value Lmax or the lower limit value Lmin of the normal operation voltage range R determined in advance.

When the DC bus voltage V_{dc} substantially coincides with the upper limit value Vmax or the lower limit value Vmin of the normal operation voltage range R, the output electric power P_{PCS} of the PCS 2 substantially coincides with the maximum electric power that can be charged or discharged from the entire storage battery unit 5. Therefore, since the control device 3 has the above-described configuration, even when an abnormality (trip or the like) occurs in some of the storage battery units 5, the control device 3 can control the storage battery 5 unit that is in operation to be chargeable and dischargeable with maximum electric power and to have the DC bus voltage V_{dc} within the normal operation voltage range R, and can continue the operation of the energy storage system 1.

In addition, when the new output power limit LM1 is received from the host device 6 and the new output power limit LM1 is lower than the output power limit LM2, the output power limit value setting unit 313 overwrites the output power limit LM2 with the value of the new output power limit LM1.

In this manner, in the control device 3, after the storage battery unit 5 is repaired or replaced again and becomes operable, the output power limit LM2 is reset by the output power limit LM1 newly instructed from the host device 6, and accordingly, it is possible to maximize the electric power that can be charged or discharged by the entire energy storage system 1.

As described above, the embodiments according to the present disclosure have been described. However, the above-described embodiments are presented as examples, and are not intended to limit the scope of the present disclosure. These embodiments can be implemented in various other embodiments, and various omissions, replacements, and changes can be made without departing from the gist of the present disclosure. These embodiments and variations thereof are included in the scope and equivalent of the present disclosure described in the claims as well as in the scope and abstract of the present disclosure.

### Supplementary Notes

The control device, the power conditioning system, the control method, and the program described in each embodiment are understood as follows, for example.
(1) According to a first aspect of the present disclosure, the control device 3 includes: the voltage acquisition unit 310 that acquires the voltage V_{dc} of the DC bus 4 connecting the PCS 2 and the storage battery unit 5; the output power limiting unit 311 that sets the output power limit LM2 of the PCS output electric power P_{PCS} which is electric power output to the load side by the PCS 2 to zero when the V_{dc} exceeds the upper limit threshold value VUL or falls below the lower limit threshold value VLL; and the limited power release unit 312 that gradually increases or gradually decreases the output power limit LM2 after the output power limit LM2 is set to zero.

In this manner, when the control device 3 detects the abnormality in the DC bus voltage V_{dc}, the control device 3 can suppress the DC bus voltage V_{dc} from exceeding the normal operation voltage range R and continue the operation by temporarily setting the output power limit LM2 of the PCS 2 to zero, returning the DC bus voltage V_{dc} to the reference voltage V₀, and then gradually increasing or decreasing the output power limit LM2.
(2) According to a second aspect of the present disclosure, the control device 3 according to the first aspect further includes the output power limit value setting unit 313 that fixes the output power limit LM2 by stopping a gradual increase or a gradual decrease in the output power limit LM2 when the voltage V_{dc} becomes the upper limit value Lmax or the lower limit value Lmin of the normal operation voltage range R determined in advance.

When the DC bus voltage V_{dc} substantially coincides with the upper limit value Vmax or the lower limit value Vmin of the normal operation voltage range R, the output electric power P_{PCS} of the PCS 2 substantially coincides with the maximum electric power that can be charged or discharged from the entire storage battery unit 5. Therefore, since the control device 3 has the above-described configuration, even when some of the storage battery units 5 trip, the control device 3 can control the storage battery 5 unit that is in operation to be chargeable and dischargeable with maximum electric power and to have the DC bus voltage Vdc within the normal operation voltage range R, and can continue the operation of the energy storage system 1.
(3) According to a third aspect of the present disclosure, in the control device 3 according to the second aspect, when the new output power limit LM1 is received from the host device 6 and the new output power limit LM1 is lower than the output power limit LM2, the output power limit value setting unit 313 overwrites the output power limit LM2 with the value of the new output power limit LM1.

In this manner, in the control device 3, after the storage battery unit 5 is repaired or replaced again and becomes operable, the output power limit LM2 is reset by the command value from the host device 6, and accordingly, it is possible to maximize the electric power that can be charged or discharged by the entire energy storage system 1.
(4) According to a fourth aspect of the present disclosure, the PCS 2 includes the control device 3 according to any one of the first to third aspects.
(5) According to a fifth aspect of the present disclosure, the control method includes: a step of acquiring the voltage Vdc of the DC bus 4 connecting the PCS 2 and the storage battery unit 5; a step of setting the output power limit LM2 of the PCS output electric power P_{PCS} which is electric power output to a load side by the PCS 2 to zero when the voltage V_{dc} exceeds the upper limit threshold value VUL or falls below the lower limit threshold value VLL; and a step of gradually increasing or gradually decreasing the output power limit LM2 after the output power limit LM2 is set to zero.
(6) According to a sixth aspect of the present disclosure, the program causes the control device 3 to execute a step of acquiring the voltage V_{dc} of the DC bus 4 connecting the PCS 2 and the storage battery unit 5, a step of setting the output power limit LM2 of the PCS output electric power P_{PCS} which is electric power output to a load side by the PCS 2 to zero when the voltage V_{dc} exceeds the upper limit threshold value VUL or falls below the lower limit threshold value VLL, and a step of gradually increasing or gradually decreasing the output power limit LM2 after the output power limit LM2 is set to zero.

### INDUSTRIAL APPLICABILITY

According to the above-described aspect, when the decrease and the increase in the DC bus voltage are detected, it is possible to suppress the DC bus voltage from exceeding the normal operation voltage range and to continue the operation.

### REFERENCE SIGNS LIST

1 Energy storage system
2 PCS
21 Inverter
3 Control device
31 Processor
310 Voltage acquisition unit
311 Output power limiting unit
312 Limited power release unit
313 Output power limit value setting unit
32 Memory
33 Storage
34 Communication interface
4 DC bus
5 Storage battery unit
51 DC/DC converter
52 Storage battery
6 Host device

1. A control device comprising:
a voltage acquisition unit that acquires a voltage of a DC bus connecting a power conditioning system (PCS) and a storage battery unit;
an output power limiting unit that sets an output power limit of PCS output electric power which is electric power output to a load side by the power conditioning system to zero when the voltage exceeds an upper limit threshold value or when the voltage falls below a lower limit threshold value; and
a limited power release unit that gradually increases or gradually decreases the output power limit after the output power limit is set to zero.

2. The control device according to claim 1, further comprising:
a output power limit value setting unit that fixes the output power limit by stopping a gradual increase or a gradual decrease in the output power limit when the voltage becomes an upper limit value or a lower limit value of a normal operation voltage range determined in advance.

3. The control device according to claim 2, wherein
the output power limit value setting unit receives a new output power limit from a host device, and when the new output power limit is lower than the output power limit, overwrites the output power limit with a value of the new output power limit.

4. A power conditioning system comprising:
the control device according to claim 1.

5. A control method comprising:
a step of acquiring a voltage of a DC bus connecting a power conditioning system (PCS) and a storage battery unit;
a step of setting an output power limit of PCS output electric power which is electric power output to a load side by the power conditioning system to zero when the voltage exceeds an upper limit threshold value or when the voltage falls below a lower limit threshold value; and
a step of gradually increasing or gradually decreasing the output power limit after the output power limit is set to zero.

6. A program that causes a control device to execute:
a step of acquiring a voltage of a DC bus connecting a power conditioning system (PCS) and a storage battery unit,
a step of setting an output power limit of PCS output electric power which is electric power output to a load side by the power conditioning system to zero when the voltage exceeds an upper limit threshold value or when the voltage falls below a lower limit threshold value, and
a step of gradually increasing or gradually decreasing the output power limit after the output power limit is set to zero.

7. A power conditioning system comprising:
the control device according to claim 2.

8. A power conditioning system comprising:
the control device according to claim 3.
